(19) United States
(12) Patent Application Publication
(10) Pub. No.: US 2024/0175541 A1
(43) Pub. Date: May 30, 2024

(54) TROPHY HOLDING DEVICE

(71) Applicant: Scott Lazenby, Williston, TN (US)

(72) Inventor: Scott Lazenby, Williston, TN (US)

(21) Appl. No.: 17/994,500

(22) Filed: Nov. 28, 2022

(51) Int. Cl. F16M 11/28; A47G 33/00

(52) U.S. Cl. CPC F16M 11/28; A47G 33/004; F16M 2200/027

(57) ABSTRACT

A trophy holding device, including a main body have an elongate shape, the main body including a first section, and a second section movably disposed within at least a portion of the first section to telescopically move from retracted within the first section in a first position to at least partially extended away from an interior of the first section in a second position, and telescopically move from extended away from the interior of the first section in the second position to retracted within the first section in the first position, a holding arm removably connected within the second section to receive at least one trophy thereon, and a base disposed on at least a portion of the first section to stabilize at least one of the first section, the second section, and or the holding arm on an external surface.

### BACKGROUND

### 1. Field

The present general inventive concept relates generally to hunting, and particularly, to a trophy holding device.

### 2. Description of the Related Art

Hunting is a human activity of pursuing and eliminating wildlife. A hunter that succeeds during a hunt will often claim the wildlife as a trophy. Typically, the hunter will preserve the trophy by taking a photograph and/or a celebratory video of the animal.

Unfortunately, the hunter usually uses a combination of hands, knees, and/or a support stick to hold the trophy in order to display the animal for the photograph and/or the video. However, a weight of the animal is often too heavy to maintain for the hunter to maintain the animal in a suitable position without being present in the photograph and/or in the video. Thus, the hunter interferes with the quality of the photograph and/or the video.

Therefore, there is a need for a trophy holding device to hold the trophy without assistance from the hunter.

### SUMMARY

The present general inventive concept provides a trophy holding device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a trophy holding device, including a main body have an elongate shape, the main body including a first section, and a second section movably disposed within at least a portion of the first section to telescopically move from retracted within the first section in a first position to at least partially extended away from an interior of the first section in a second position, and telescopically move from extended away from the interior of the first section in the second position to retracted within the first section in the first position, a holding arm removably connected within the second section to receive at least one trophy thereon, and a base disposed on at least a portion of the first section to stabilize at least one of the first section, the second section, and or the holding arm on an external surface.

The first section may have a size greater than a size of the second section.

The holding arm may include a support body having a plurality of arms, and a friction surface disposed on at least a portion of the support body to prevent the at least one trophy from slipping away from the support body.

The trophy holding device may further include a height adjustment lock movably disposed on at least a portion of the first section to prevent the second section from extending away from the first section while locked, and allow the second section to extend away from the first section while unlocked.

The trophy holding device may further include a section lock disposed within at least a portion of the first section to prevent the second section from moving beyond the section lock within the first section.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a trophy holding device with a height adjustment lock in a closed position, according to an exemplary embodiment of the present general inventive concept; and

FIG. 2 illustrates a side perspective view of the trophy holding device with the height adjustment lock in an opened position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Trophy Holding Device 100
Main Body 110
First Section 111
Second Section 112
Holding Arm 120
Support Body 121
Friction Surface 122
Base 130
Height Adjustment Lock 140
Section Lock 150

Device props up animals head on a pole to improve documentation of kill. Eliminates need for users to physically hold up the animal which allows clear, uninterrupted pictures and/or video. Can be used to showcase rifle, shotgun.

Telescopic pole with V-shape to stabilize animal thereon. Put head on V shape and modify height accordingly. Adjust size based on size of animal. Camoflouge color. Bottom part is also V shape and is bigger than top part holding animal.

a trophy holding device to receive at least one item thereon, such that the trophy holding device is telescopically adjustable in length using pressure latch, single end button clip, double end button clip, compression ring, flip lever clamps, quick release ball lock pin, split collar lock, spiral button, snap lock, set knob, swaging pin, clutch telescopic tube lock, twist lock, pressure twist lock, set screw, such that a first end is V-shaped and a second end is V-shaped, such that the first end is interchangeable for size, such that the first end is interchangeable using quick release, screw in, and/or single/double end button clip, such that the second is bipod, tripod, or with a flat bottom plate, such that the trophy holding device supports up to 150 lbs, such that the first end has rubber material to prevent slipping

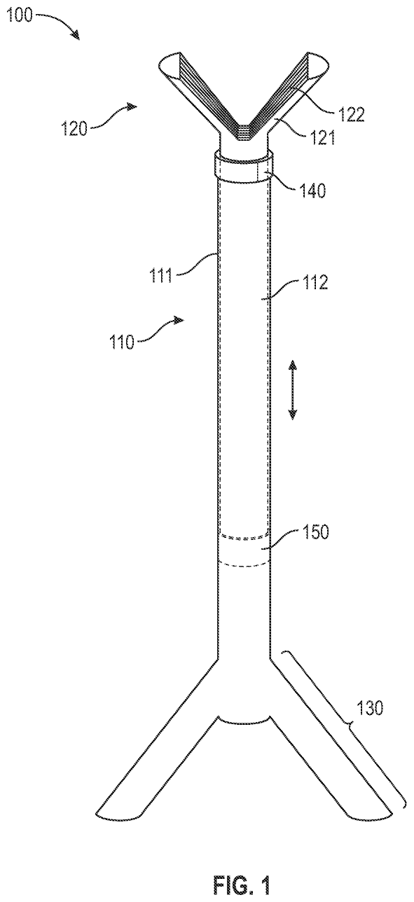

FIG. 1 illustrates a side perspective view of a trophy holding device 100 with a height adjustment lock 140 in a closed position, according to an exemplary embodiment of the present general inventive concept.

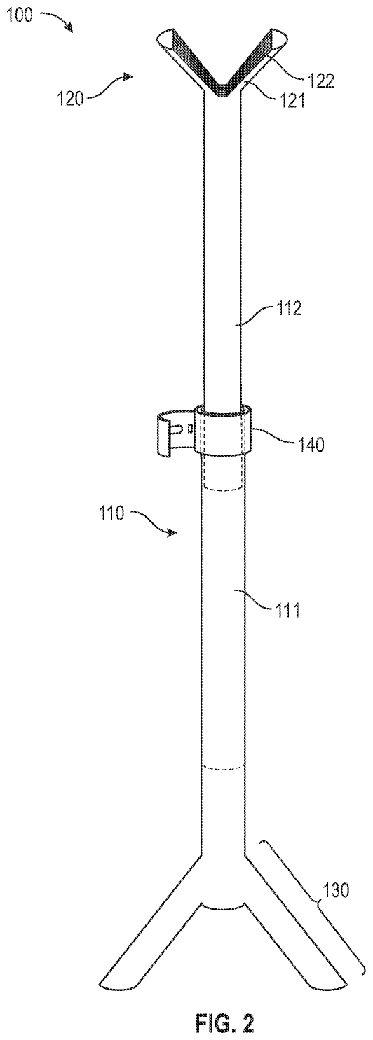

FIG. 2 illustrates a side perspective view of the trophy holding device with the height adjustment lock 140 in an opened position, according to an exemplary embodiment of the present general inventive concept.

The trophy holding device 100 may be constructed from at least one of metal, aluminum, steel, composite metal, plastic, acrylic, carbon fiber, polyurethane, wood, and rubber, etc., but is not limited thereto.

The trophy holding device 100 may include a main body 110, a holding arm 120, a base 130, a height adjustment lock 140, and a section lock 150, but is not limited thereto.

Referring to FIGS. 1 and 2, the main body 110 is illustrated to have a cylindrical shape and/or an elongate shape. However, the main body 110 may be rectangular, circular, triangular, pentagonal, hexagonal, heptagonal, octagonal, or any other shape known to one of ordinary skill in the art, but is not limited thereto.

The main body 110 may include a first section 111 and a second section 112, but is not limited thereto.

The first section 111 may have a camouflage design on an outer surface thereof. As such, the first section 111 may blend into an outdoor environment. The first section 111 may have a size (e.g., a diameter, a circumference) greater than a size (e.g., a diameter, a circumference) of the second section 112. The first section 111 may have a fixed size and/or a predetermined size.

The second section 112 may be movably (i.e., slidably) disposed within at least a portion of the first section 111. More specifically, the second section 112 may move from retracted within the first section 111 in a first position to at least partially extended away from an interior of the first section 111 in a second position. Conversely, the second section 112 may move from extended away from the interior of the first section 111 in the second position to retracted within the first section 111 in the first position. In other words, the second section 112 may telescopically move with respect to the first section 111 to increase an entire length and/or an entire height of the first section 111 and/or the second section 112 from an external surface (e.g., a ground surface).

The holding arm 120 may include a support body 121 and a friction surface 122, but is not limited thereto.

The support body 121 may be removably connected (i.e., inserted without tools and/or fasteners, such as screws, bolts, nails, washers, nuts) within an aperture of the second section 112 (i.e., at a first end of the main body 110). The support body 121 may have arms protruding therefrom to form a V shape. However, the support body 121 may form any type of shape. Moreover, the support body 121 may receive at least one trophy (e.g., deceased animal, deceased wildlife) thereon. The support body 121 and/or the main body 110 may support a predetermined weight (e.g., one hundred fifty pounds) thereon.

Thus, the support body 121 may be exchanged for another support body 121 with different shapes and/or sizes.

The friction surface 122 may include a rubber surface, a knurled surface, and a textured surface (e.g., a plurality of bubbled protrusions extending away therefrom), but is not limited thereto.

The friction surface 122 may be disposed on at least a portion of the support body 121. The friction surface 122 may increase a friction level on the support body 121. Additionally, the friction surface 122 may prevent slipping of the at least one trophy away from the support body 121 while disposed on the support body 121 and/or the friction surface 122.

Referring again to FIGS. 1 and 2, the base 130 is illustrated to be a bipod. However, the base 130 may be a tripod and/or a flat plate based on a preference of a user and/or a manufacturer.

The base 130 may be disposed on at least a portion of the first section 111 (i.e., at a second end of the main body 110). The base 130 may be removably disposed on at least a portion of the external surface. As such, the base 130 may stabilize and/or support the first section 111, the second section 112, and/or the holding arm 120 on the external surface.

The height adjustment lock 140 may include a pressure latch, a single end button clip, a double end button clip, a compression ring, a plurality of flip lever clamps, a quick release ball lock pin, a split collar lock, a spiral button, a snap lock, a set knob, a swaging pin, a clutch telescopic tube lock, a twist lock, a pressure twist lock, and a set screw, but is not limited thereto.

The height adjustment lock 140 may be movably (i.e., pivotally, rotatably, slidably) disposed on at least a portion of the first section 111. The height adjustment lock 140 may move from closed (i.e., locked) in a first position to at least partially opened (i.e., unlocked) in a second position. Conversely, the height adjustment lock 140 may move from opened in the second position to closed in the first position. As such, the height adjustment lock 140 may prevent the second section 112 from extending away from the first section 111 while closed and allow the second section 112 to extend away from the first section 111 while opened.

It is important to note that the second section 112, the holding arm 120, the base 130, and/or the height adjustment lock 140 may have the camouflage design.

The section lock 150 may be disposed within at least a portion of the first section 111. The section lock 150 may prevent the second section 112 from moving beyond the section lock 150 within the first section 111. As such, the section lock 150 may prevent the second section 112 from falling into the first section 111 beyond an entirety of a length of the second section 112.

Therefore, the trophy holding device 100 may hold the at least one trophy to facilitate taking a photograph and/or a video. Also, the trophy holding device 100 may prevent a hunter from having to hold the at least one trophy. The trophy holding device 100 may also be used to display a weapon, such as a gun, a rifle, a shotgun, and/or a bow.

The present general inventive concept may include a trophy holding device 100, including a main body 110 have an elongate shape, the main body 110 including a first section 111, and a second section 112 movably disposed within at least a portion of the first section 111 to telescopically move from retracted within the first section 111 in a first position to at least partially extended away from an interior of the first section 111 in a second position, and telescopically move from extended away from the interior of the first section 111 in the second position to retracted within the first section 111 in the first position, a holding arm 120 removably connected within the second section 112 to receive at least one trophy thereon, and a base 130 disposed on at least a portion of the first section 111 to stabilize at least one of the first section 111, the second section 112, and or the holding arm 120 on an external surface.

The first section 111 may have a size greater than a size of the second section 112.

The holding arm 120 may include a support body 121 having a plurality of arms, and a friction surface 122 disposed on at least a portion of the support body 121 to prevent the at least one trophy from slipping away from the support body 121.

The trophy holding device 100 may further include a height adjustment lock 140 movably disposed on at least a portion of the first section 111 to prevent the second section 112 from extending away from the first section 111 while locked, and allow the second section 112 to extend away from the first section 111 while unlocked.

The trophy holding device 100 may further include a section lock 150 disposed within at least a portion of the first section 111 to prevent the second section 112 from moving beyond the section lock 150 within the first section 111.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A trophy holding device, comprising:
a main body have an elongate shape, the main body comprising:
a first section, and
a second section movably disposed within at least a portion of the first section to telescopically move from retracted within the first section in a first position to at least partially extended away from an interior of the first section in a second position, and telescopically move from extended away from the interior of the first section in the second position to retracted within the first section in the first position;
a holding arm removably connected within the second section to receive at least one trophy thereon, the holding arm comprising:
a pair of support arms disposed in a V-shape to extend upwards from a topmost surface of the holding arm; and
a base disposed on at least a portion of the first section to stabilize at least one of the first section, the second section, and or the holding arm on an external surface.

2. The trophy holding device of claim 1, wherein the first section has a size greater than a size of the second section.

3. The trophy holding device of claim 1, wherein the holding arm further comprises:
a friction surface disposed on at least a portion of the support body to prevent the at least one trophy from slipping away from the support body.

4. The trophy holding device of claim 1, further comprising:
a height adjustment lock movably disposed on at least a portion of the first section to prevent the second section from extending away from the first section while locked, and allow the second section to extend away from the first section while unlocked.

5. The trophy holding device of claim 1, further comprising:
a section lock disposed within at least a portion of the first section to prevent the second section from moving beyond the section lock within the first section.
